(19) United States
(12) Patent Application Publication
(10) Pub. No.: US 2005/0068563 A1
(43) Pub. Date: Mar. 31, 2005

(54) System and method for printing electronic files

(76) Inventors: Truc Nguyen, San Diego, CA (US); William Su, Riverside, CA (US); George Mylonas, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/674,662

(22) Filed: Sep. 30, 2003

(51) Int. Cl. G06F 15/00; H04N 1/00

(52) U.S. Cl. 358/1.15; 358/402

(57) ABSTRACT

The present invention relates to a system and method for printing electronic files. The present invention enables a user to create a plurality of electronic files, specify print setting information for each electronic file, and associate the specified print setting information with each electronic file in a manner adapted for storage. The present invention further enables a user to print a plurality of electronic files in response to a print request, wherein each of the electronic files is printed in accordance with the specified print setting information.

### BACKGROUND OF THE INVENTION

Users of a computer typically create documents to be printed. When the user inputs a request to the computer to print the document, the user specifies print setting information according to which an imaging device, such as a printer, processes the document. The “finishing” attribute is an example print setting that can provide a number of options, such as stapling options and hole punching options. If the user does not specify print setting information, the document will be processed according to default settings. If, at a subsequent time, the user inputs a request to print the document again, the user will be required to specify print setting information. Thus, the print setting information is not stored with the document in a manner that eliminates the need for the user to reinput print setting information on subsequent print requests.

Additionally, the ability to print multiple documents at once is a desired network feature. Conventional systems do not allow a user attempting to print multiple documents to specify print setting information for each document. Further, because print setting information cannot be saved with documents, a laborious task is presented for the user attempting to print multiple documents at once.

Thus, it is desirable to have a system and method for specifying print setting information for a document and for associating the print setting information with the document. It is further desirable to have a system and method for printing a plurality of documents at once, wherein each document is printed according to the print setting information associated with each document.

### SUMMARY OF THE INVENTION

In accordance with the present invention, there is provided a method and system for printing electronic files. According to one aspect of the present invention, a user is able to associate with an electronic file print setting information in a manner adapted for storage, which file is adapted for later retrieval and printing according to the print setting information associated with the file.

In accordance with another aspect, the present invention provides a system for printing electronic files comprising: means adapted for receiving an electronic file, wherein the electronic file is representative of a document image; means adapted for specifying print setting information; means adapted for creating a print job by associating the electronic file with the specified print setting information; means adapted for receiving data representative of a user request to select the print job; and means adapted for receiving data representative of a user request to print the print job.

In accordance with another aspect, the present invention provides a method for printing electronic files comprising: receiving an electronic file, wherein the electronic file is representative of a document image; specifying print setting information; creating a print job by associating the electronic file with the specified print setting information; receiving data representative of a user request to select the print job; and receiving data representative of a user request to print the print job.

Still further in accordance with another aspect, the present invention provides a method for printing multiple documents and merging one or more documents into a single document for email, export, printing or file storage.

These and other aspects, advantages and features of the invention will be understood by one of ordinary skill in the art upon a reading and understanding of the specification.

### BRIEF DESCRIPTION OF THE DRAWINGS

FIG. 1 is schematic of an example system for the present invention;

FIG. 2 is an example user interface, according to the present invention; and

FIG. 3 is a flowchart illustrating an example method according to the present invention.

### DESCRIPTION OF EXAMPLE EMBODIMENTS OF THE PRESENT INVENTION

Disclosed according to the present invention is a system and method for merging a plurality of print jobs to be printed in response to a single print request. Further according to the present invention, each of the print jobs merged comprises print setting information associated with the print job.

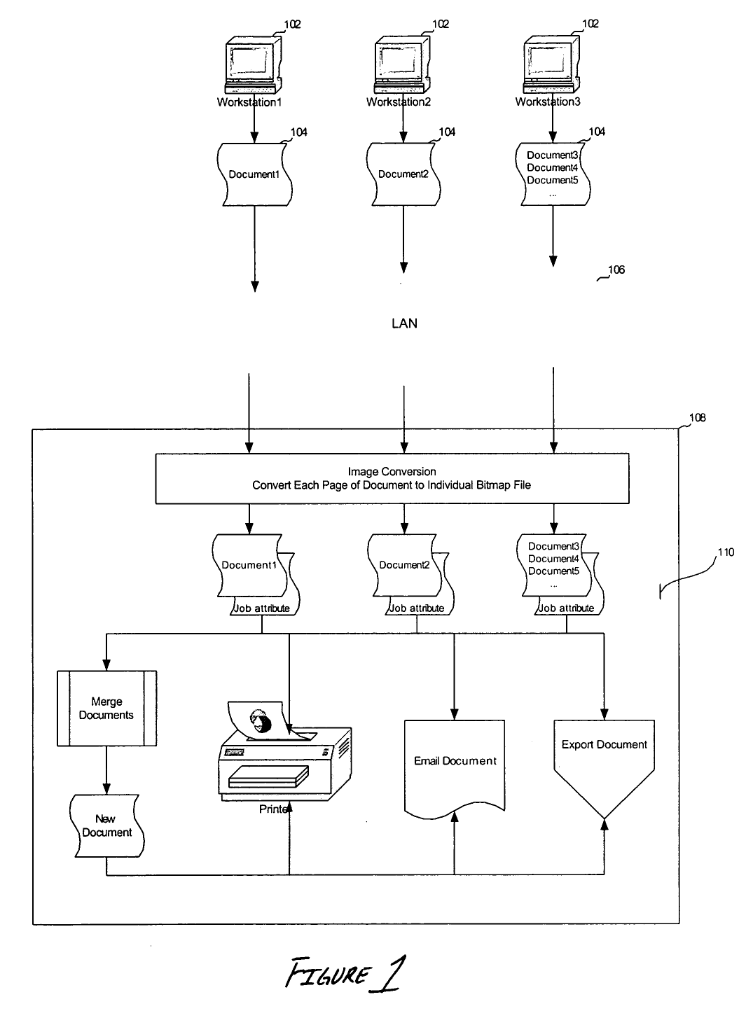

With reference to FIG. 1, illustrated is an example system 100 according to the present invention. The system 100 generally includes a computer 102, a data transfer network 106 and an imaging device 108. According to the present invention, the computer 102 is provided with at least one software application for processing an electronic file. The software application may suitably enable the user to create the electronic file by inputting the electronic file through an input device such as a keyboard. Additionally, the software application may suitably enable the user to download and manipulate a previously created electronic file, such as, for example, by downloading the electronic file from a portable memory medium (e.g., diskette) or from the Internet, etc. As a further example, the software application may suitably enable a user to input an electronic file from an inputting device, such as a scanner, copier, facsimile machine, etc. The examples of means for causing the computer 102 to have the electronic file are for illustration only and are not intended to limit the scope of the invention.

An example software application is a word processing application. The word processing application suitably provides the user with an application for creating an electronic file representative of a textual document. Thus, through the word processing application, the user creates the electronic file and is able to direct the processing of the electronic file by the imaging device 108, which processing may include printing.

According to the present invention, when the user inputs a print request to the software application for printing the electronic file, the application will prompt the user to specify print setting information. As an example, the application may display a printer interface, such as a graphical printer interface, which interface presents the user with a plurality of print setting options. The print settings may include such options as a number of copies of the electronic file to be printed by the printer, an orientation for the electronic file, such as portrait or landscape, and finishing options, such as collating options and assembly options (e.g., stapling). Once the user has specified the print setting information, the print request is recommunicated (for example, by clicking “print” on a displayed menu) to the application. The application receives the print request and transmits a series of commands describing the electronic file and the specified print setting information to a printer driver stored on the computer 102.

According to an example aspect of the present invention, the printer driver is provided with means for associating the electronic file with the specified print setting information in a manner adapted for the storage of the electronic file and associated print setting information as a unit. The associating means associates the electronic file with the specified print setting information, thereby creating a print job, which print job is capable of storage and subsequent retrieval. Upon subsequent retrieval, a print request can be communicated to the software application associated with the print job, which print request will cause the print job to be processed by the imaging device 108 according to the print setting information originally specified by the user and associated with the electronic file by the associating means. The associating means is suitably any device, method, computer readable code, etc. as known in the art for associating as provided. Additionally, the associating means may suitably be provided as a component of the imaging device 108, such as a controller of the imaging device 108.

The printer driver may suitably perform additional processing of the electronic file and print setting information. As previously mentioned, the printer driver associates the electronic file and the print setting information into the print job. However, the printer driver may, prior to the association, process the electronic file into print data representative of the electronic file. As an example, the print data refers to electronic data in any format that is used to describe the electronic file, and may be expressed in Printer Control Language (PCL), PostScript (PostScript is a trademark owned by Adobe Systems, Inc.), as a raster bitmap, or in any other form as known in the art.

According to an example embodiment of the present invention, the print job may suitably also comprise setup commands. The setup commands can be provided in any appropriate language as known in the art. According to an example embodiment, the setup commands are provided in Printer Job Language (PJL). As a further example, the PJL commands may be provided in a preamble section of the print job, wherein the PJL commands preface the electronic file (or print data, if present) component of the print job. The PJL commands may suitably include any commands as known in the art. According to an example, the PJL commands include commands related to the print setting information specified by the user, which commands are recognized by the imaging device 108 and direct the imaging device 108 to process the print job in accordance with the commands.

Once the print job is created, the user is presented with a plurality of storage locations in which to save the print job. For example, the user suitably saves the print job on the computer 102, in which case the computer 102 is provided as a local storage medium. As another example, if the computer 102 is provided as a client computer in a network system, the user may save the print job in a network-provided storage medium, such as a server computer have a memory device. As yet another example, the imaging device 108 is provided with a controller storage 110, in which case the user suitably saves the print job in the controller storage 110. Further according to the controller storage example, the controller storage 110 may be provided with means for receiving the print job, converting the print job to a bitmap file, and storing the bitmap file on the controller storage 110. It is to be understood that the storage locations described herein are by way of example only, and any suitable storage device or combination of storage devices as known in the art may be employed in the present invention.

As suggested by the foregoing disclosure, the system 100 can be implemented in a variety of configurations. According to one embodiment of the present invention, the system is suitably implemented in a stand alone computer system, i.e., a computer 102 that is not connected to a network. According to another embodiment as previously mentioned, the system 100 is suitably implemented in a networked computer arrangement. Such a system is illustrated in FIG. 1 and generally includes a plurality of computers 102, the data transfer network 106 and the imaging device 108. In this arrangement, the computers 102 are provided as client computers and the system may suitably be provided with at least one server computer. The data transfer network 106 provides a communication link across which the plurality of computers 106 and the imaging device 108 communicate. The data transport network is illustrative of a LAN, a secure LAN (SLAN) or WAN environment, such as a packet-switched TCP/IP-based global communication network. The network is suitably any network and is preferably comprised of physical layers and transport layers, as illustrated by a myriad of conventional data transport mechanisms like Ethernet, Token-Ring™, 802.11(b), or other wire-based or wireless data communication mechanisms as will be apparent to one of ordinary skill in the art. The network may contain any additional elements as known in the art, such as a server computer and may contain more than one of any of the above elements.

The system 100 additionally includes the imaging device 108 for processing the print job. Depending on the arrangement of the system 100, the imaging device 108 may be directly connected to the computer 102, directly connected to the data transfer network 106, or indirectly connected to the network 106 by being connected to a computer 106 that is, in turn, connected to the network 106. Additionally, the system 100 may be provided with a plurality of imaging devices 108, with a variety of connections to the computer 106 and/or the network 106 possible.

According to the present invention, the imaging device 108 may be any device capable of processing the print job. Such devices include, for example, printers, laser printers, dot matrix printers, bubble jet printers, multifunction devices, or any other like device. The imaging device 108 may be provided with one or more of the following components: an input/output (I/O) port, a processor, a controller, a memory, an engine and a bus connecting all the included components. The I/O port provides the imaging device 108 the ability to receive the print jobs over a communications link from the computer 102. The engine may employ any number of technologies, as known in the art, for generating printed output. For example, the engine may be a laser engine, an ink-jet engine, an impact printer or thermal printer, etc.

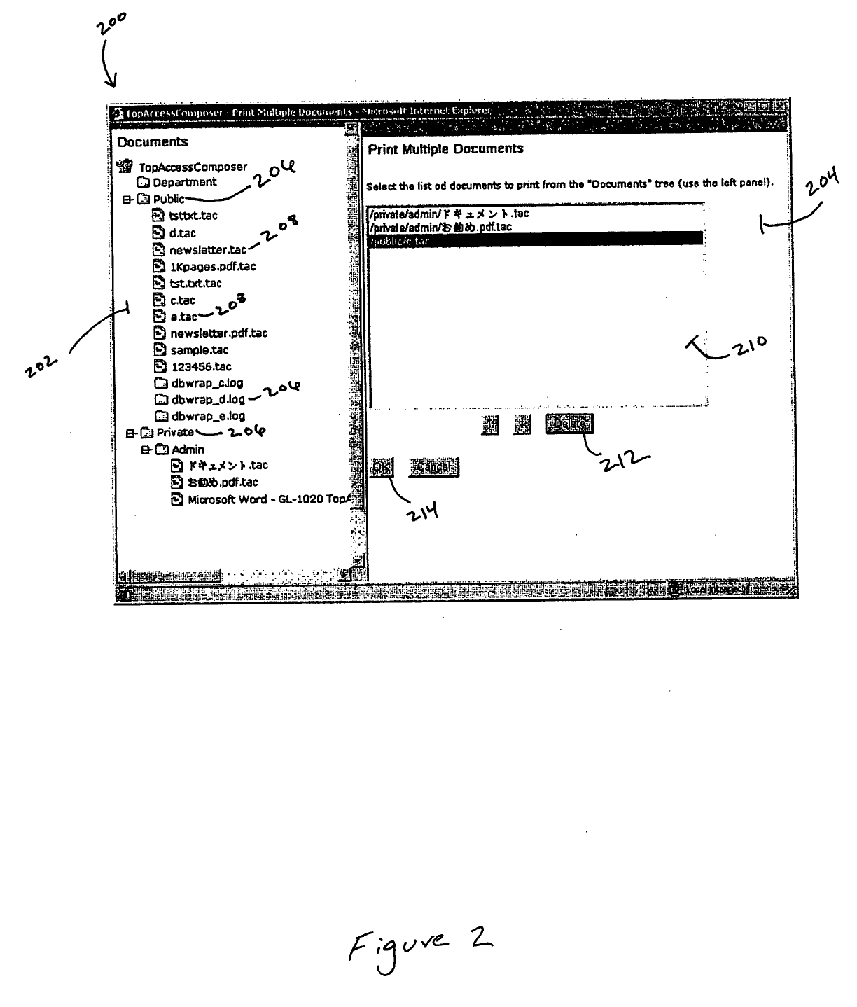

Disclosed in FIG. 2 is an example user interface 200 for executing the present invention. The user interface 200 is suitably displayable on the computer 102 and comprises a folder management component 202 and a print unit creation component 204. The folder management component 202 provides the user with access to the files 206 accessible by the computer 102 on which the user interface 200 is executed. For example, in a networked computer system, the folder management component 202 suitably provides the user with access to the files available on the local computer, files available on the data transfer network 106, and any other like available files. As previously discussed, the user (or multiple users in the situation of a networked computer system) creates and saves print jobs to the files 206. Through use, the files 206 may suitably contain a plurality of print jobs created according to the present invention. Thus, folder management component 202 enables the user to select a plurality of print jobs to be printed in response to a print request.

In operation, the user highlights each print job to be printed. Examples of the print jobs are shown in FIG. 2 as element 208. As an example, the user may suitably double click on each desired print job 208, which double clicking causes the print jobs 208 to be displayed in a window 210 of the print unit creation component 204. As the user highlights the desired print jobs 208, the window 210 suitably displays a print unit, i.e., a list of the print jobs 208 selected to be printed. The user is suitably provided with options for altering the list of print jobs 208 in the window 210. For example, a delete 212 button may be provided for removing certain print jobs 208 from the list displayed in the window 210.

Once the user has highlighted all desired print jobs 208 and the window 210 represents the desired print unit, the user interface 200 is further provided with a means 214 for printing the print unit in response to a print request. For example, the means 214 is suitably an “OK” button, the clicking of which causes the print unit, including each print job that comprises the print unit, to be printed. Thus, all selected print jobs will be printed in response to a single print request. Additionally, because each print job comprises print setting information associated therewith, the clicking of the OK button further causes each print job of the print unit to be printed according to each print job's associated print setting information. Thus, the user is not required to reinput print setting information for each print job when attempting to later print.

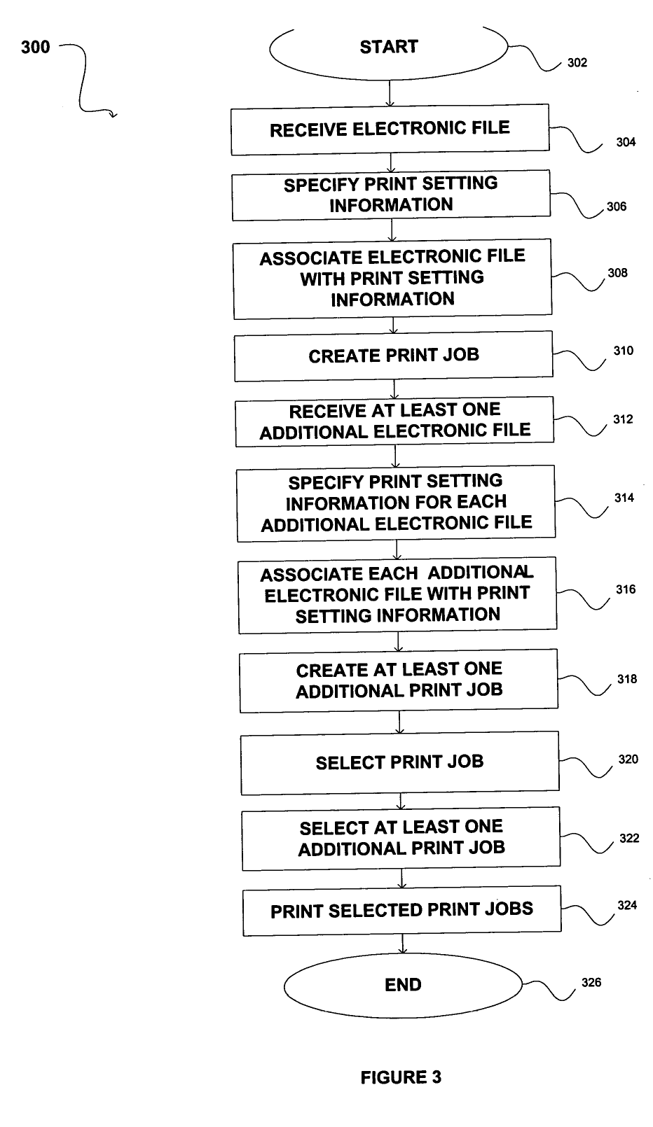

With reference to FIG. 3, illustrated is an example method 300 according to the present invention. The method begins at step 304 with the user receiving an electronic file and continues at 306 with the user specifying print setting information for the file, as discussed above. At step 308 the specified print setting information is associated with the file, which association thereby creates a print job in step 310. As discussed above, multiple print jobs can be created according to the present invention. Thus, in step 312, additional electronic files are received and in step 314 print setting information is specified for each additional received electronic file. In step 316, the additional electronic files are associated with the specified print setting information, thereby creating additional print jobs, as in step 318. In step 320, the user selects the print job, and in step 322, the user selects additional print jobs, as described above. Finally, in step 324, the user inputs a print request for printing the selected print jobs.

Although the preferred embodiments have been described in detail, it should be understood that various changes, substitutions and alterations can be made therein without departing from the spirit and scope of the invention as defined by the appended claims. It will be appreciated that various changes in the details, materials and arrangements of components, which have been herein described and illustrated in order to explain the nature of the invention, may be made by those skilled in the art within the principle and scope of the invention as will be expressed in the appended claims.

1. A system for printing electronic files comprising:
means adapted for receiving an electronic file, wherein the electronic file is representative of a document;
means adapted for generating print setting information;
conversion means adapted for converting the electronic file to an image file;
means adapted for creating a print job by associating the image file with the print setting information;
means adapted for receiving data representative of a user request to select the print job for output to at least one selected destination, the at least one selected destination including at least one of a printed copy of the document, an e-mail inclusive of the image file, and an electronic copy of the image file; and
means adapted for receiving data representative of a user request to output the print job.

2. The system of claim 1, wherein the print job comprises at least one command representative of the specified print setting information.

3. The system of claim 3, wherein the at least one command is in a printer job language format.

4. The system of claim 1 wherein the means adapted for creating a print job includes a printer driver.

5. The system of claim 1, further comprising storage means adapted for storing the print job.

6. The system of claim 1, further comprising:
means adapted for receiving at least one additional electronic file, wherein the at least one additional electronic file is representative of a document image;
means adapted for specifying at least one additional print setting information;
means adapted for creating at least one additional print job by associating the at least one additional electronic file with the specified print setting information;
means adapted for receiving data representative of a user request to select the at least one additional print job; and
means adapted for receiving data representative of a user request to output the at least one additional print job to a selected output destination.

7. A method for printing electronic files comprising:
receiving an electronic file, wherein the electronic file is representative of a document;
generating print setting information;
converting the electronic file to an image file;
creating a print job by associating the image file with the print setting information;
receiving data representative of a user request to select the print job for output to at least one selected destination, the at least one selected destination including at least one of a printed copy of the document, an e-mail inclusive of the image file, and an electronic copy of the image file; and
receiving data representative of a user request to output the print job.

8. The method of claim 7, wherein the print job comprises at least one command representative of the specified print setting information.

9. The method of claim 8, wherein the at least one command is in a printer job language format.

10. The method of claim 10, wherein the print job is created with a printer driver.

11. The method of claim 10, further comprising:
receiving at least one additional electronic file, wherein the at least one additional electronic file is representative of a document image;
specifying at least one additional print setting information;
creating at least one additional print job by associating the at least one additional electronic file with the specified print setting information;
receiving data representative of a user request to select the at least one additional print job; and
receiving data representative of a user request to print the at least one additional print job.

12. A computer readable medium of instructions for printing electronic files comprising:
means adapted for receiving an electronic file, wherein the electronic file is representative of a document;
means adapted for generating print setting information;
conversion means adapted for converting the electronic file to an image file;
means adapted for creating a print job by associating the image file with the print setting information;
means adapted for receiving data representative of a user request to select the print job for output to at least one selected destination, the at least one selected destination including at least one of a printed copy of the document, an e-mail inclusive of the image file, and an electronic copy of the image file; and
means adapted for receiving data representative of a user request to output the print job.

13. The system of claim 12, wherein the print job comprises at least one command representative of the specified print setting information.

14. The system of claim 13, wherein the at least one command is in a printer job language format.

15. The system of claim 15 wherein the means adapted for creating a print job is a printer driver.

16. The system of claim 12 further comprising a storage means adapted for storing the print job.

17. The system of claim 12, further comprising:
means adapted for receiving at least one additional electronic file, wherein the at least one additional electronic file is representative of a document image;
means adapted for specifying at least one additional print setting information;
means adapted for creating at least one additional print job by associating the at least one additional electronic file with the specified print setting information;
means adapted for receiving data representative of a user request to select the at least one additional print job; and
means adapted for receiving data representative of a user request to print the at least one additional print job.

18. A computer-implemented method for printing electronic files comprising:
receiving an electronic file, wherein the electronic file is representative of a document;
generating print setting information;
converting the electronic file to an image file;
creating a print job by associating the image file with the print setting information;
receiving data representative of a user request to select the print job for output to at least one selected destination, the at least one selected destination including at least one of a printed copy of the document, an e-mail inclusive of the image file, and an electronic copy of the image file; and
receiving data representative of a user request to output the print job.

19. The method of claim 18, wherein the print job comprises at least one command representative of the specified print setting information.

20. The method of claim 19, wherein the at least one command is in a printer job language format.

21. The method of claim 18, wherein the print job is created via a printer driver.

22. The method of claim 18, further comprising:
receiving at least one additional electronic file, wherein the at least one additional electronic file is representative of a document image;
specifying at least one additional print setting information;
creating at least one additional print job by associating the at least one additional electronic file with the specified print setting information;
receiving data representative of a user request to select the at least one additional print job; and
receiving data representative of a user request to print the at least one additional print job.
